(19) United States
(12) Patent Application Publication
(10) Pub. No.: US 2005/0160037 A1
(43) Pub. Date: Jul. 21, 2005

(54) Method for automatically preparing payment instruments at a point-of-sale location

(75) Inventor: David Kumhyr, Austin, TX (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/758,862

(22) Filed: Jan. 16, 2004

(51) Int. Cl. G06F 17/60

(52) U.S. Cl. 705/40; 705/64

(57) ABSTRACT

The present invention is a method and system for automatically preparing payment instrument at a point-of-sale location. In this invention, the information required for payment using a check instrument will be automatically printed on the check in the proper location by the point-of-sale terminal device. This information will include the name of the payee, the numerical amount of the sale and the written amount of the sale. Once the information is printed on the check, the customer can review the check and sign the check. This process is more efficient and reduces the amount of time usually required by the customer to complete the required information on the check.

### FIELD OF THE INVENTION

This invention relates generally to the paying of goods using a check and more particularly to a method and system for speeding the transaction time for a check transaction by automatically preparing the check for the customer, then presenting the check to the customer for approval and signature.

### BACKGROUND OF THE INVENTION

One of the primary ways of paying for goods and services is with a check. With the exception of a cash payment, paying via check is probably the most widely accepted form of payment. Checks provide a short-term form of credit until the merchant receives the funds for which the check was written and accepted by the merchant. With the use of checks as a form of payment, the modern world would be a drastically different place with regard to the purchase of goods and services.

The use of a check as a payment instrument requires that the payer complete portions of the check, which define the identification of the payee, the amount to be paid, the date of the instrument, and authorizing signature. In many situations, the merchant (payee) also requires that the customer provide an identification number (such as a driver's license or a telephone number) on the negotiable check so that the check can be matched to a specific customer. Sometimes this identifier is a long complex arrangement of letters and numbers, which requires great concentration on the part of the check writer to ensure accuracy of the information.

Because of the necessity for the accuracy of the information supplied on the check, the check writing process can become an increasingly fatigued and irritable process. In addition, when a person has to write several checks, their handwriting may degrade to a point where it is almost impossible to read or discern what is being written on the check. Even further, for many elderly check writers, they easily become confused and often enter conflicting information on the check. This confusion normally occurs where the numerical amount must match the written amount of the check. This ambiguity results in a check being returned to the user, which furthers the accounting and payment problems.

One solution to this problem implemented by many elder persons is to have someone else write out the check and then the elderly person will sign the check. This process is manual and does not work when there is no one available or willing to assist the person trying to write the check.

One particular situation in which check writing is an annoyance is during the purchase of goods at a store. One of the delays during the checkout process is waiting for persons paying by check to complete the information required on the check. This process can result in long lines at the checkout counter. Some stores post signs containing information that is required for the check to be accepted at that store. Some of the information refers to the ‘name of the payee’ that should be on the check. These efforts are intended to help speed up the checkout process when paying by check. However, with all that the stores are doing to make the process more efficient, because of the human element, the process is still slow and inefficient.

There have been attempts to address some of the issues related to writing checks. Many of these solutions are in the area of making the information on the checks more legible. Because of the processing problems, numerous attempts have been made to remove the chances of errors. One solution attempts to address the issue of preparing checks at the point-of-sale. U.S. Pat. No. 5,440,106 to Duck, provides a printer and system which assists in the preparation and completion of check writing at a point-of-sale. This system employs a printer, which prints information onto labels for the critical areas of the check or negotiable instrument, such information includes the tendered amount, payee, and date. The labels are removed from their substrate and permanently adhered to the check. In addition, a separate label, containing the same information, is supplied the customer for completion of the ledger associated with the check. In this manner, the entire check writing process is completed quickly and thereby increasing the efficiency of the checkout counter.

Other solutions to problem of check writing focus on a way to eliminate the need to manually write checks at the point of sale location. One present trend is to replace the check with a check card to pay for items. This card works in a manner similar to a credit card. The payee will swipe the card and the card number is read into the system. The amount of the sale is then electronically deducted from the checking account of the payee. Although this process is popular, many people still prefer to use an actual check to pay for their items. In addition, the check card raises some security issues similar to the issues associated with the use of credit cards.

Other solutions also focus on the desire to remove the human element completely from the payment process. One solution described in U.S. Application No. 2003/0033252 A1 uses the information from a blank check submitted to the cashier at the time of sale to pay for the items. In this method, the information from the scanned blank check is stored in the system of the store. In addition, this check posting method includes receiving and storing a transaction amount, checking account information from a blank check, an electronic image of a face of the blank check, and biometric information from an owner of the checking account such as an electronic image of a handwritten signature or fingerprint from an owner of the checking account. An electronic check posting transaction request may be generated from the transaction amount and the checking account information and forwarded for settlement.

In none of these situations address the basic problem of preparing a check for payment at the point-of sale location. Although the Duck patent attempts to address this problem, there still remains a need to an efficient solution to the problem of long delays in preparing a check for payment at the point of sale (POS) of a good or service.

### SUMMARY OF THE INVENTION

It is an objective of the present invention to provide a more efficient method for payment of goods and services when the method of payment is a check instrument.

It is a second objective of the present invention to provide a method and system for preparing payment instruments at the point-of-sale (POS).

It is a third objective of the present invention to provide a method and system to produce check payment instruments that are more legible.

It is a fourth objective of the present invention to provide a check writing system at the POS location that can write specific and unique customer information on the check, such as driver's license number or a social security number.

It is a fifth objective of the present invention to provide a check writing method that can write the store transaction number on the check to link the check to a specific transaction for later refunding useful on the pay with check refund for schemes.

It is a sixth objective of the present invention to provide a check writing method that can ensure that the legal amount and convenient amount written on the always match and thereby improving efficiency in processing the check.

The present invention is a system and automated method for preparing a payment instrument at the point-of-sale location. This invention enables a customer to submit a check to a cashier at the time of sale. The cashier can scan the check through the point-of-sale terminal and prepare a final check containing all of the information for the sale. The customer can then review the check for approval and signature. This process will reduce the amount of time currently required by a customer to fill in the information on the check. This process will also in some case provide a more legible document for the banking or financial institution processing the instrument.

In the method of the present invention, as with conventional payment methods, the cashier will ring up all of the items that the customer desires to purchase. At the completion of this process, the cashier (checkout terminal) will calculate the total cost for the merchandise. At this point, the customer can hand the cashier a blank check instrument. The cashier will then scan the check into the terminal device. Once in the terminal, all of the required information related to the sale of the goods will be printed on the check in the appropriate location. This information will include the name of the payee, the convenience amount of the check, the legal amount of the check and the date. At this point, the cashier will hand the completed check to the customer for review, approval and signature.

In addition to the above-described primary information to be printed on the check, the present invention also provides for additional information that can be included on a check. One option is to print out on the memo line a description of the sale. Other information that can be printed on the check can include specific store code information such as register number, cashier number, customer's driver's license number, or customer telephone number. Some merchants require customers to include driver's license and telephone number information on the checks. To have this information printed on the check by the POS terminal could also enhance security against identity theft from others gaining access to a customer's driver's license number especially in states where the social security number is used as the drivers' license number.

The present invention provides several benefits over the conventional method of preparing checks for payment at a point of sale location. These benefits include:
1) The amount of the check printed in both the convenience amount field and the legal field will be accurate and will be the same as the actual transaction amount.
2) The method of the present invention can be used in automated checkout schemes since there is a certainty for the merchant that the check is for the amount of the sale. This process will reduce the need to employ expensive handwriting recognition software or an employee to validate the check.
3) The customer identification and specific information such as driver's license number can be printed on the check at the time of the sale in order to reduce identification theft.
4) The store transaction number can be put on the check to link the store to a specific transaction for later refunding useful on the pay with check refund for cash schemes or to properly credit the purchaser with the sale.
5) If the checkout terminal is capable of MICR printing, the MICR amount field can be printed and read with an immediate ‘bank of first deposit’ processing done.

### DESCRIPTION OF THE DRAWINGS

FIG. 1 is an illustration of a typical personal check.

FIG. 2 is an illustration of a typical personal check containing payment information.

FIG. 3 is an illustration of the different sections of a personal check, which contain designated information.

FIG. 4 is an illustration of a completed personal check in accordance with the present invention.

FIG. 5 is a flow diagram of the general steps in the implementation of the present invention.

FIG. 6 is a flow diagram of an alternate implementation of the present invention.

FIG. 7 is a configuration of the system of the present invention.

### DETAILED DESCRIPTION OF THE INVENTION

The present invention provides a method and system to automatically prepare a check for payment at the point-of-sale location. Shown in FIG. 1 is a typical personal check. The physical features, dimensions and characteristics of this type of check are established by the banking industry. As shown in this check 10, at the far top left of the check is the name and address 11 of the check owner. At the far top right is the check number 12. The next information entry on the check is the location for the date 13. The check writer will provide the date that the check is written in this location. Below the date is the ‘Pay to the order of’ designation, where the check writing provides the name of the “payee’ 14. Adjacent the payee designation is the location for the amount of the check 15 (also known as the convenience amount). This location is for a number designation of the check amount. Below both the payee designation and the numerical amount designation is the written check amount description 16 (also known as the legal description). In order for the check to be written in proper form, the numerical and written check amounts must match. Below the written check amount is the name of the financial institution 17 holding the account from which the funds will be drawn to pay the amount of the check. This account is usually the account of the check owner. Below the name of the financial institution is a memo line 18. On this line, the check writing can enter a brief description of the nature or purpose of the check. Adjacent the memo line is the location 19 for the check writer to sign the check. This signature gives the financial institution the authority to pay funds out of the check writer's account to the designated payee to satisfy the obligation of the writer to the payee. Below the memo line is the check routing number 20. This number is a numerical identification of the financial institution. The checking account number 21 is positioned below the signature line 19. In addition, below the name and address 11, there can be a space 22 for optional information such as a store code, register/terminal number, cashier number, customer driver's license, telephone number or social security number.

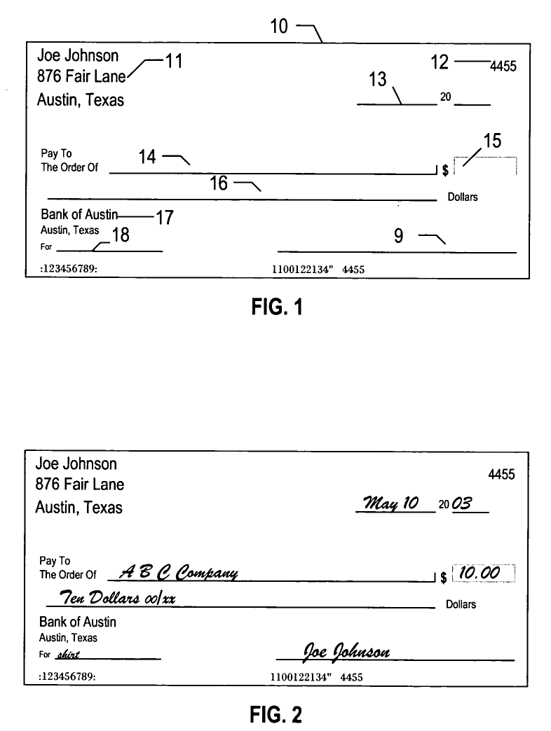

FIG. 2 shows a manually prepared check ready for payment. In this example, the check writer supplies the date of the check 13, the payee name 14, the numerical amount of the check 15, the written amount of the check 16, the purpose of the check 18 and the signature 19. For different individuals, the amount of time required to provide the information required to properly complete the check will vary. In some instances, this time variance can impact other people, such as at the point-of-sale location with other persons waiting in line behind the check writer.

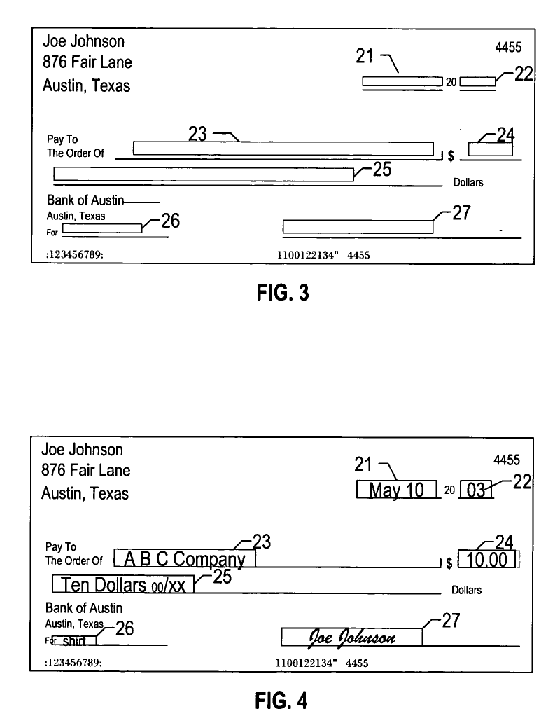

As mentioned, the present invention provides a method to reduce the amount of time required to prepare a check at a point-of-sale location. In the present invention, the check is prepared and printed out at the point-of-sale terminal. FIG. 3 shows the different areas of a check where the check writer provides information. Because of the standard design for personal checks established by the banking industry, these areas are in the same locations on each personal check. As a result, present software in the terminal can print specific information in each of these locations. Alternatively, a scanner could be built into the terminal to establish the locations on the check for specific information and assure during printing that the information being rendered into the correct fields. For purposes of this description, these locations will be referred to as check fields. The printing process for this present invention can be designed and implemented in a manner that is similar to other standard printing schemes for terminals at POS locations. In FIG. 3, area 21 is the date of the check. The print program can be designed to print out a numerical representation for the date such as 5-10. The numeral ‘5’ represents the month and the numeral ‘10’ represents the date. The other alternative would be to spell out the month i.e. ‘May’. The ‘year’ field 22 can contain at least the last two digits of the current year. Field 23 is the ‘payee’ field. This field will contain the name of the payee. If the commercial establishment is the “ABC Company”, then this name would be printed in this field. Field 24 is the location for the numerical amount of the sale. Field 25 is the location for the written amount of the sale. Field 26 is an optional field that describes a purpose for the sale. As mentioned, this information is primarily for the benefit of the check writer. Depending of the technology implemented at the point-of-sale location, the check writer may be able to enter an electronic signature that would be printed on the check in field 27. An example of the technology to facilitate an electronic signature could be an electronic pad such those currently used to enter purchaser signatures for credit card transactions. In the present instance, once the check writer enters his/her signature on the electronic pad, the signature would appear on the check in field 27.

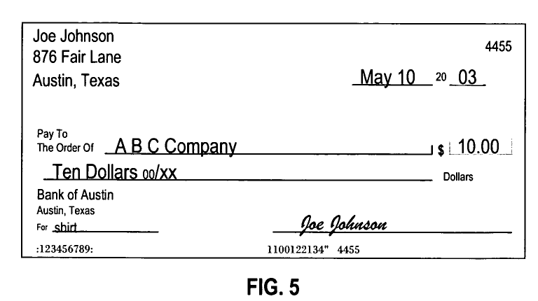

FIG. 4 illustrates a completed check in accordance with the present invention and shows the information in the designated fields. FIG. 5 shows the completed check of FIG. 4, as it would appear at a point-of-sale location.

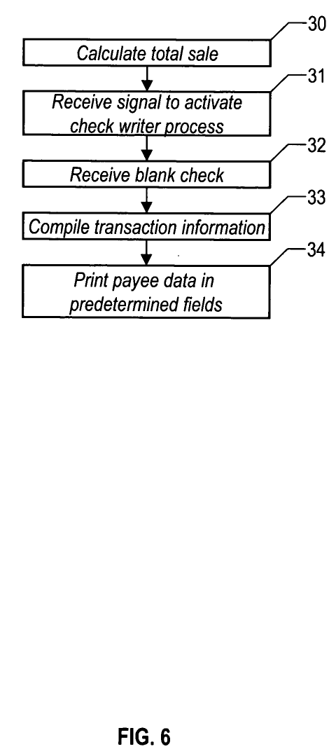

Referring to FIG. 6, illustrated is a method of implementation of the present invention. This method can be implemented with software installed in the terminal used at the point-of-sale location. During step 30, the amount for this sale is calculated at the point-of-sale location as is done with any sale. If the customer desires to have their check printed by the terminal in accordance with the present invention, the customer will hand the cashier person a standard blank personal check. At this point, the cashier can take some action, such as inputting a code, to initiate this automated check writing process. As a result of the initiation action by the cashier in step 30, the method of the present invention will receive a signal to activate this check writer process in step 31. Because currently checks are inserted into the terminal and merchant deposit information is printed on the back of the check, it is necessary to activate a different process for this printing activity. In step 32, the blank check is received inside the terminal. Step 33 will compile and/or retrieve the specific information related to the POS transaction that will be printed on this check. As mentioned, this information will include the date, name of payee, the numerical and written amount of the sale and the memo description. This information would be printed on the check in the previously described fields in step 34. This printing process may be similar to a standard process for printing addresses on envelopes wherein the sender address and the destination address have specific locations on the envelope (document). At the completion of this check printing process in step 34, the check is presented to the customer for review and signature.

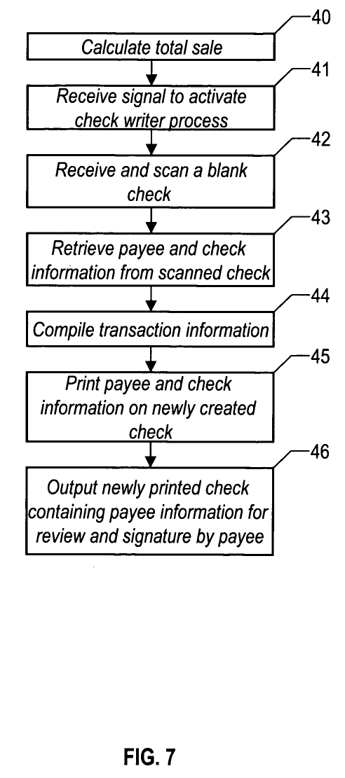

FIG. 7 provides an alternate embodiment of the present invention. In this embodiment, the customer submits a check, but instead printing the information on the same check, a new check is printed containing all of the information on the blank check and the information that comprises the point-of-sale information. In this embodiment, steps 40, 41 and 42 are the same as steps 30, 31, and 32 of FIG. 6. If the decision is to have the check printed, the cashier takes the blank check and inserts it into the terminal. Step 43 scans in the check and retrieves the information on the check. Step 44 compiles the information for the new check. This information includes the scanned check information and the information from the sales transaction. Step 45 prints all of the compiled information on the new check. At this point, step 46 outputs the newly created check. The original scanned black check is destroyed at the point-of-sale location or other location. In either case, the customer will not get back the original blank check. As with the method of FIG. 6, the customer will receive the check from the cashier and will have the opportunity to review and sign the check. Also with this method, depending on the technology at the business establishment, the customer may be able to enter his/her signature on the check electronically via an electronic pad. In this case, the customer's signature will also be printed on the check with the other check information.

FIG. 8 illustrates a system for the present invention. As shown, there can be a terminal that contains the software for printing on checks in accordance to the present invention. However, most sales terminals are part of a larger network. For this invention, all of the components should be able to be located in the sales terminal. In addition, payment terminals currently have printing capabilities for printing sales receipts. In addition, these terminals also have the ability to print information on the back of the check. The current printing capabilities of the terminal can be modified via software to print the information on the face/front of check in accordance with the present invention.

As indicated in the above description, the present invention provides several benefits over the conventional method of preparing checks for payment at a point of sale location. These benefits include: 1) the amount of the check printed in both the convenience amount field and the legal field will be accurate and will be the same as the actual transaction amount; 2) the method of the present invention can be used in automated checkout schemes since there is a certainty for the merchant that the check is for the amount of the sale; 3) the customer identification and specific information such as driver's license number can be printed on the check at the time of the sale in order to reduce identification theft; 4) the store transaction number can be put on the check to link the store to a specific transaction for later refunding useful on the pay with check refund for cash schemes or to properly credit the purchaser with the sale; and 5) if the checkout terminal is capable of MICR printing, the MICR amount field can be printed and read with an immediate ‘bank of first deposit’ processing done.

This invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention, which is limited only by the following claims.

1. A method for preparing check payment instrument using a payment terminal at the point-of-sale location comprising the steps of:
calculating a total sale amount;
in response to a user input, activating the check writing process;
receiving a blank check in a the payment terminal;
retrieving transaction information for current sales transaction;
printing the transaction information on the check in defined check fields; and
outputting the check.

2. The method as described in claim 1 further comprising before said total calculating step, the step of defining information fields corresponding to specific physical locations on a blank check.

3. The method as described in claim 2 wherein said information fields defining step further comprising determining the dimensions of the check and determining physical coordinates and physical dimensions for each field.

4. The method as described in claim 1 further comprising before said printing step, the step of aligning the received blank check in the payment terminal.

5. The method as described in claim 2 wherein said printing step further comprises printing specific transaction information in each defined field of the blank check.

6. The method as described in claim 1 wherein the transaction information comprises the amount of the sale, the date of the sale, and the name of the payee.

7. The method as described in claim 5 further comprising before said printing step, the step determining whether the customer will submit an electronic signature.

8. The method as described in claim 7 further comprising when the determination is that the customer will submit an electronic signature, the step of;
retrieving an electronic signature and printing the retrieved signature in a designated signature field on the check.

9. A computer program product in a computer readable medium for preparing check payment instrument using a payment terminal at the point-of-sale location comprising:
instructions for calculating a total sale amount;
in response to a user input, instructions for activating the check writing process;
instructions for receiving a blank check in a the payment terminal;
instructions for retrieving transaction information for current sales transaction;
instructions for printing the transaction information on the check in defined check fields; and
instructions for outputting the check.

10. The computer program product as described in claim 9 further comprising before said total calculating instructions, instructions for defining information fields corresponding to specific physical locations on a blank check.

11. The computer program product as described in claim 10 wherein said information fields defining instructions further comprise instructions for determining the dimensions of the check and determining physical coordinates and physical dimensions for each field.

12. The computer program product as described in claim 9 further comprising before said printing instructions, instructions for aligning the received blank check in the payment terminal.

13. The computer program product as described in claim 10 wherein said printing instructions further comprise instructions for printing specific transaction information in each defined field of the blank check.

14. The computer program product as described in claim 12 further comprising before said printing instructions, instructions for determining whether the customer will submit an electronic signature.

15. The computer program product as described in claim 14 further comprising when the determination is that the customer will submit an electronic signature, instructions for retrieving an electronic signature and printing the retrieved signature in a designated signature field on the check.

16. The method as described in claim 1 further comprising before said compiling step, the step of retrieving the information from the scanned blank check.

17. The method as described in claim 16 wherein said compiled transaction information includes the scanned blank check information.

18. The method as described in claim 17 wherein said printing step further comprises printing the compiled information onto a newly created check.

19. A system for preparing check payment instrument using a payment terminal at the point-of-sale location comprising:
a check feeder mechanism for accepting the check;
a processor to calculate the amount of a sale;
a memory location storing information that to be provided related to the sale on the check; and
a printer for printing the information on the check.

20. The system as described in claim 19 further comprising a scanner to established locations on the check for printing information related to the sale.
